(19) United States
(12) Patent Application Publication
(10) Pub. No.: US 2003/0154954 A1
(43) Pub. Date: Aug. 21, 2003

(54) Method of ignition and corresponding ignition unit

(76) Inventors: Manfred Vogel, Ditzingen (DE); Werner Herden, Gerlingen (DE)

Correspondence Address: KENYON & KENYON, ONE BROADWAY, NEW YORK, NY, 10004, US

(21) Appl. No.: 10/312,937

(22) PCT Filed: Apr. 5, 2001
(86) PCT No.: PCT/DE01/01317

(30) Foreign Application Priority Data
Jun. 3, 2000 (DE) 10031875.4

(51) Int. Cl. F02B 3/04; F02B 17/00

(52) U.S. Cl. 123/295; 123/305

(57) ABSTRACT

The present invention provides an ignition method for an internal combustion engine, an injection being alternatively carried out in at least one first operating mode (H1, H2) or in a second operating mode (S), and the ignition coil being charged as a function of the current operating mode. A control-pulse curve (SI) characteristic of the current operating mode is provided, and the charging of the ignition coil (ZS) is carried out by a control logic element (L) in response to the control-pulse curve (SI), using corresponding, different time characteristics of the primary current. The present invention also provides a corresponding ignition device for an internal combustion engine.

### BACKGROUND INFORMATION

The present invention relates to an ignition method for an internal combustion engine, an injection being alternatively carried out in at least one first operating mode or in a second operating mode, and the ignition coil being charged as a function of the current operating mode; and the present invention relates to a corresponding ignition device.

Although applicable to any fuels and engines of any vehicles, the present invention and the problem on which it is based are explained with reference to a direct gasoline-injection system of an engine of a passenger car.

FIG. 4 illustrates the dependence of torque M on engine speed N for different operating modes of an internal combustion engine.

During so-called homogeneous, normal operation H1 of the direct gasoline-injection system, the entire combustion chamber is homogeneously filled with a stoichiometric air-fuel mixture (lambda value λ=1), which is ignited by the ignition sparks at the ignition firing point. In this case, there are no ignition problems at all when the mixture has a high energy density.

However, homogeneous operation may also be realized in a lean manner and/or with exhaust-gas recirculation (AGR) as homogeneous operation H2. In this case, a high level of flow is generally required in order to achieve sufficiently rapid burning in the case of low energy densities of the mixture in the combustion chamber. This deflects the spark plasma, until it breaks away and reignition occurs.

By this means, the spark energy during coil ignition is distributed with typical spark durations of approximately 1 ms under these conditions, to numerous, subsequent sparks, which each reach new mixture regions.

But since the leanest operation or so-called high-AGR operation is only attained when the entire energy of the ignition coil is introduced into a single flame core, all of the energy stored in the ignition coil must therefore be supplied in such a short time that the spark still does not break away within this span of time (typically approximately 0.3-0.6 ms.).

This yields a demand for as high an energy as possible and a very short spark duration (approximately 0.3-0.6 ms) for this H2 operation, which results in a high, required initial current of 150-200 mA.

In order to completely make use of the fuel-consumption advantage with internal combustion engines having direct gasoline injection, so-called charge stratification is implemented in the combustion chamber in certain operating ranges, which is referred to below as stratified-charge operation S.

During stratified-charge operation S, only a small, locally ignitable stoichiometric cloud is introduced into the combustion chamber, whereas the remaining contents of the combustion chamber cannot be ignited. The advantage of this stratified-charge operation S is that the lean-combustion operation of the engine is extended, and fuel is therefore saved in the end. Therefore, it is desirable to design the operating range of stratified-charge operation S to be as large as possible, and in particular, to therefore expand it to loads and engine speeds that are as high as possible.

During stratified-charge operation S, marked local and/or temporal lambda fluctuations may be present at the location of the ignition spark, when the average energy density in the mixture cloud is high. In order to achieve reliable ignition in this case, the spark should burn for a long time (typically, approximately 5-10° KW (KW=crank angle)), so that within this time, the formation of the flame core may always be started when a flammable mixture region is seized by the spark plasma.

In this context, depending on the flow of the mixture at the spark plug, only a continuously decreasing portion of the electrical energy introduced from the ignition coil may be available for forming the flame core as the spark duration increases, which is why the known proposal was made to generate a pulse train, i.e. to repeatedly charge and discharge the ignition coil, within the above-mentioned KW interval.

Therefore, an individual ignition spark that burns as along as possible with a typical initial current of approximately 50-80 mA and a typical secondary energy of approximately 80-100 mJ, or an adjustable-length pulse train with an initial current of approximately 100 mA from a coil having approximately 30 mJ of secondary energy, is suitable for this stratified operating mode.

Since the demands for stratified S and homogeneous H1 and H2 operating ranges are therefore markedly different, a conventional system design having individual sparks creates a conflict of aims, which could previously only be approached as a compromise. An ignition coil may either be designed for a long spark duration (high secondary inductance, i.e. high number of secondary windings per unit length) with a moderate initial current, or for a short spark duration (low secondary inductance, i.e. low number of secondary windings per unit length). Therefore, a decision for a discrete design as a compromise is absolutely necessary.

### SUMMARY OF THE INVENTION

In contrast to the known design approaches, the ignition method of the present invention having the features of claim 1, and the corresponding ignition device according to claim 6, have the advantage that a functionality adapted to the problem of direct gasoline-injection engines allows optimum ignition in stratified operation, as well as in homogeneous lean-combustion operation and/or with AGR, and in cold starting or other critical engine conditions.

The operating mode may be controlled as needed. Only the amount of energy required for ignition is introduced. This prevents unnecessary spark-plug wear.

A smaller space for the coil due to a smaller number of turns per unit length on the secondary side, or a larger iron cross section, is possible in the same space. Therefore, a cost advantage may be attained by dispensing with the magnets for pre-magnetizing the iron circuit.

The idea forming the basis of the present invention is that the type of ignition suitable for the specific operating mode is provided by control-pulse coding. For example, a pulse-train ignition suitable for stratified operation is combined with the option of loading the ignition coil with a markedly higher amount of energy during homogeneous operation by increasing the primary current, so that it still discharges as a single spark within the desired spark duration of approximately 0.3-0.6 ms.

Delineated in the dependent claims are advantageous embodiments of the particular subject matter of the present invention, as well as improvements thereto.

According to a preferred, further refinement, the first operating mode is a homogeneous, normal operation, which is divided up into the submodes of stoichiometric normal operation and sub-stoichiometric normal operation, and the second operating mode is an inhomogeneous stratified-charge operation.

A further, preferred refinement provides for the charging of the ignition coil during inhomogeneous, stratified-charge operation being carried out in the form of pulse-train ignition with a predetermined primary current, and the charging of the ignition coil during homogeneous operation being carried out in the form of a single-pulse ignition with an increase in the primary current.

According to a further, preferred refinement, the control-pulse curves characteristic of the current operating mode have different pulse times and/or numbers of pulses. Thus, virtually as many operating states as possible may be coded, using simple means.

A further, preferred refinement provides for the iron circuit of the ignition coil being controlled up to the start of saturation, in an operating mode that requires a high initial spark current. The advantage of this design is that more energy may be stored and the rate of increase of the voltage is increased because of the lower, secondary inductance at the beginning.

### BRIEF DESCRIPTION OF THE DRAWINGS

Exemplary embodiments of the present invention are represented in the drawings and are explained in detail in the following description.

FIG. 1 a representation of the curve of spark current i_{F} versus time t according to a first, specific embodiment of the present invention;

FIG. 2 a representation of the curve of spark current i_{F} versus time t according to a second, specific embodiment of the present invention;

FIG. 3 a schematic representation of a control device for realizing the first and second, specific embodiments; and

FIG. 4 the dependence of torque M on engine speed N for different operating modes of an internal combustion engine.

### DESCRIPTION OF THE EXEMPLARY EMBODIMENTS

FIG. 1 is a representation of the curve of spark current i_{F} versus time t according to a first, specific embodiment of the present invention.

In FIG. 1, curve a) represents the spark-current characteristic in the form of the discharge of the ignition coil (secondary energy approximately 30 mJ, primary interrupting current approximately 10 A), without the pulse-train characteristic. The initial, secondary-side spark current is approximately 110 mA with a spark duration of approximately 0.35 ms and a spark voltage of 1500 V.

Curve b) shows this ignition coil during the generation of a pulse train having four pulses, in which, in each case, the primary-side re-energization of the ignition coil occurs when the spark current has decreased to approximately 50 mA. A battery voltage of 42 V is assumed in order to realize the short recharging time.

In general, it should be mentioned that, in the case of a battery voltage of 14 V customary in known methods heretofore, the short recharging time may be achieved by increasing the primary current from 10 A to 30 A.

Curve c) shows the spark-current characteristic for homogeneous operation H1 or H2, namely when the coil is charged to approximately two times the energy, 60 mJ, by increasing the primary-side interrupting current (from approximately 10 A to 15 A).

This yields a spark duration of approximately 0.5 ms, given an initial current that is increased to approximately 160 mA.

This first exemplary embodiment assumes that the coil is in the linear range of the magnetizability.

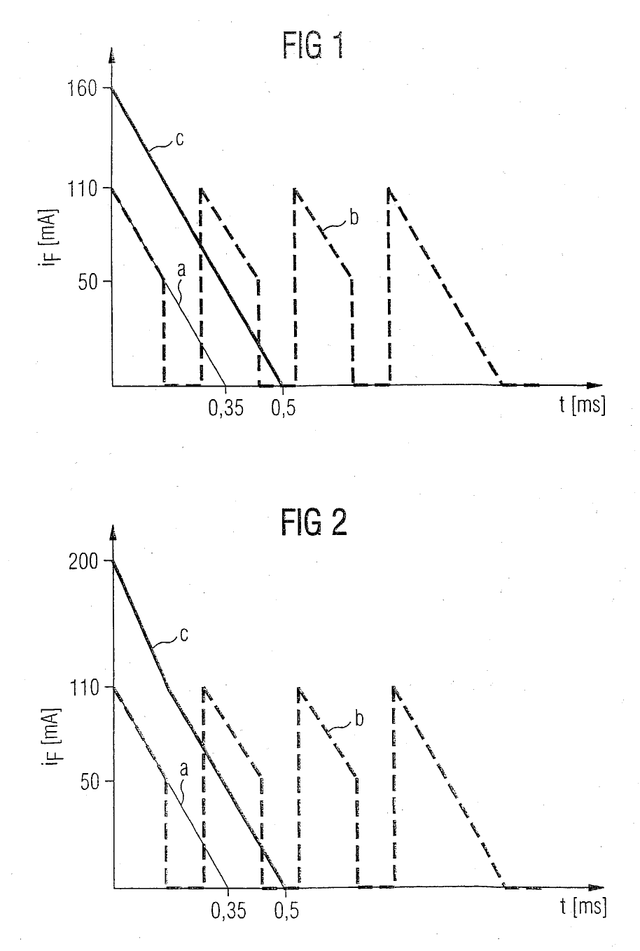

FIG. 2 is a representation of the curve of spark current i_{F} versus time t according to a second, specific embodiment of the present invention.

In this second exemplary embodiment according to FIG. 2, it is assumed that, due to the limited space (bar coil), a linear increase in the magnetizability may no longer be achieved, but rather the nonlinearity of the magnetization is intentionally incorporated.

Curve a) represents the spark-current characteristic as the discharge of the ignition coil (bar coil, secondary energy approximately 30 mJ, primary interrupting current approximately 10 A), without the pulse-train characteristic. As in the first example mentioned above, the initial, secondary-side spark current is approximately 110 mA with a spark duration of approximately 0.35 ms.

As in the first example mentioned above, curve b) shows this ignition coil during the generation of a pulse train having four pulses, in which, in each case, the primary-side re-energization of the ignition coil occurs when the spark current has decreased to approximately 50 mA. In this case, a battery voltage of 42 V is likewise assumed in order to realize the short recharging time.

Curve c) shows the spark-current characteristic for homogeneous operation, namely when the coil is charged to approximately two times the energy, 60 mJ, by increasing the primary-side interrupting current (from approximately 10 A to 20 A). This yields an increased initial spark current of 200 mA, which decreases in a nonlinear manner, i.e. more steeply at the beginning, since a lower inductance is initially present on account of the saturation property. A sufficiently short spark duration of approximately 0.5 ms is also obtained in this case.

This design has two advantages. When space is limited (bar coil), more energy can be stored when the iron circuit is activated up to the start of saturation. The rate of increase of the voltage increases because of the lower, secondary inductance at the beginning. The increased rate of voltage increase has a positive effect in the case of spark-plug shunting, i.e. carbon-fouled spark plugs (cold starting).

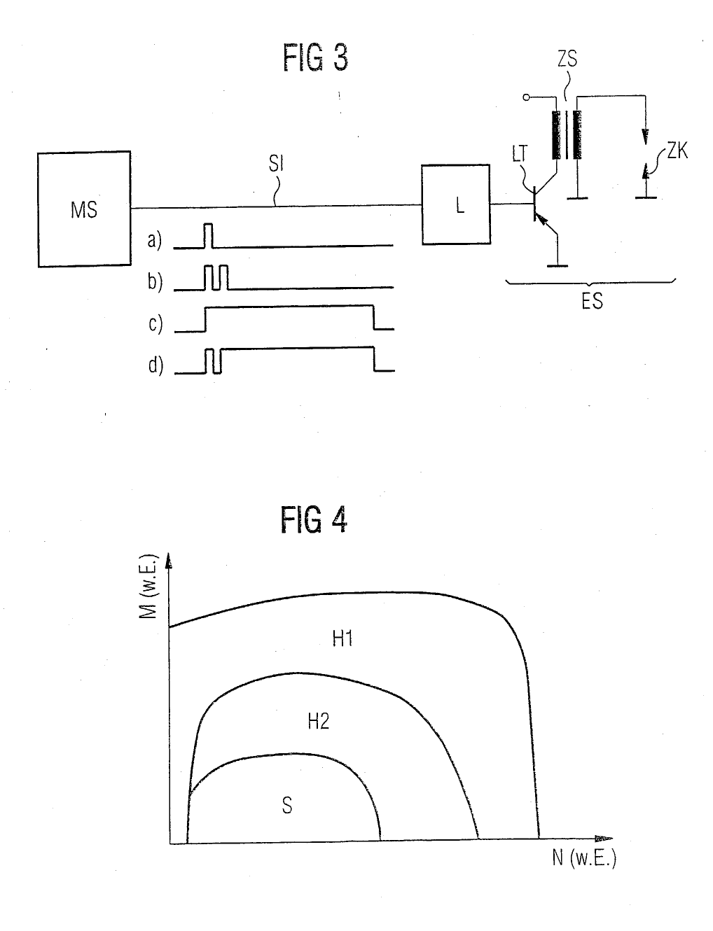

FIG. 3 shows a schematic representation of a control device for realizing the first and second, specific embodiments.

In particular, MS designates an engine control unit, L a control logic, and ES an output stage, which includes a power transistor LT, a spark plug ZK, and an ignition coil ZS as fundamental components. It is assumed that the electronics which generate a pulse train, i.e. control logic element L and output stage ES, are situated on/in ignition coil ZS.

A control pulse SI, which has a code from which control logic element L can locally recognize if a low-energy pulse train, a high-energy pulse train, a single, low-energy pulse, or a single, high-energy pulse is desired, is supplied by engine control unit MS as a function of the current injection mode.

FIG. 3 shows examples of suitable codes:

a) a single, short control pulse SI (approximately 10-100 μs): single 30 mJ spark during homogeneous operation with λ=1;

b) two short control pulses SI (each approximately 10-100 μs): single 60 mJ spark during homogeneous, lean-combustion operation, optionally with AGR;

c) a long control pulse SI (approximately 1-5 ms): pulse train base, 30 mJ, during stratified-charge operation;

d) a long control pulse SI (ca. 1-5 ms) after a short control pulse SI (approximately 10-100 μs): 60 mJ pulse train base during cold starting and/or maneuvering, or under other particularly critical engine conditions.

Although the present invention is described above on the basis of preferred exemplary embodiments, it is not limited to them, but can be modified in a number of ways.

In particular, the present invention is not limited to the illustrated pulse shapes, energies, spark durations, and the like, but can be generalized as needed. Further injection modes or different injection modes may also be provided.

What is claimed is:

1. An ignition method for an internal combustion engine, an injection being alternatively carried out in at least one first operating mode (H1, H2) or in a second operating mode (S), and the ignition coil being charged as a function of the current operating mode;
wherein a control-pulse curve (SI) characteristic of the current operating mode is provided; and the charging of the ignition coil (ZS) is carried out by a control logic element (L) in response to the control-pulse curve (SI), using corresponding, different time characteristics of the primary current.

2. The method as recited in claim 1,
wherein the first operating mode (H1, H2) is homogeneous, normal operation, which is subdivided into the submodes of stoichiometric, normal operation (H1) and
sub-stoichiometric, normal operation (H2), and the second operating mode (S) is inhomogeneous, stratified-charge operation.

3. The method as recited in claim 2,
wherein the loading of the ignition coil during inhomogeneous, stratified-charge operation (S) is carried out in the form of a pulse-train ignition, using a predetermined primary current, and the loading of the ignition coil during homogeneous operation (H1, H2) is carried out in the form of a single-pulse ignition with an increase in the primary current.

4. The method as recited in one of the preceding claims 2 or 3,
wherein the control-pulse curves (SI) characteristic of the current operating mode have different pulse times and/or numbers of pulses.

5. The method as recited in one of the preceding claims,
wherein the iron circuit of the ignition coil is controlled up to the start of saturation, in an operating mode that requires a high initial spark current.

6. An ignition device for implementing the method as recited in at least one of the preceding claims, having:
an ignition output stage (ES);
a control logic element (L) connected in incoming circuit to the ignition output stage (ES); and
an engine control unit (MS) for generating a control-pulse curve (SI) characteristic of the current operating mode;
in response to the control-pulse curve (SI), the control logic element (L) adjusting the output stage (ES) to a corresponding time characteristic of the primary current.
